(19) United States
(12) Patent Application Publication
(10) Pub. No.: US 2024/0279523 A1
(43) Pub. Date: Aug. 22, 2024

(54) EPOXY RESIN COMPOSITIONS AND METHODS OF MAKING

(71) Applicant: Westlake Epoxy Inc., Houston, TX (US)

(72) Inventors: Christoph SCHEUER, Dinslaken (DE); Gabriele BADINI, Dusseldorf (DE); Alexander LINZNER, Bottrop (DE); Thomas DRESSEN, Xanten (DE)

(21) Appl. No.: 18/108,460

(22) Filed: Feb. 10, 2023

(51) Int. Cl. C09K 5/14; B32B 27/20; B32B 27/26; B32B 27/38; C08K 3/34; C08L 63/00; H05K 7/20

(52) U.S. Cl. CPC C09K 5/14; B32B 27/20; B32B 27/26; B32B 27/38; C08K 3/34; C08L 63/00; H05K 7/2039; B32B 2307/302; C08K 2003/343; C08K 2201/001

(57) ABSTRACT

Embodiments of the present disclosure generally relate to epoxy resin compositions, methods of making epoxy resin compositions, and to uses of epoxy resin compositions. In an embodiment, the composition includes an epoxy resin, a latent catalytic curing agent, and a filler. The composition can be used in an article. In an embodiment, an article includes a heat-generating member, and a composition disposed on the heat-generating member, the composition comprising: an epoxy resin, a latent catalytic curing agent, and a filler.

### FIELD

Embodiments of the present disclosure generally relate to epoxy resin compositions, methods of making epoxy resin compositions, and to uses of epoxy resin compositions.

### BACKGROUND

Thermal management of electrical devices such as electric motors, electric generators, components of vehicles, among others continues to gain increased attention as the demand for such devices increases. As increased power density is sought, the amount of heat that needs to be dissipated also increases, making it important to have proper thermal management. Ineffective or insufficient thermal management leads to poor device performance and decreased longevity as the overheating damages materials, generates cracks, and deforms structures in and around electrical devices. Safety can also be negatively affected. Therefore, proper thermal management of electrical devices is required to improve the reliability, performance, safety, and lifetime of the electrical devices.

Although several thermal management techniques are known, such as resin compositions, heat sinks, thermoelectric coolers, forced air systems, among others, such techniques have varying degrees of effectiveness. For example, the equipment required for thermoelectric coolers and forced air systems is bulky, heavy, and expensive. Such size and complexity are prohibitive in many applications. Conventional resin compositions for thermal management are two component (2K) systems requiring on-site mixing. In addition, thermal conductivities of conventional resin compositions are too low for effective thermal management of electrical devices.

Therefore, there is a need for new and improved compositions for thermal management.

### SUMMARY

Embodiments of the present disclosure generally relate to epoxy resin compositions, methods of making epoxy resin compositions, and to uses of epoxy resin compositions. Embodiments described herein can be used for thermal management of various electrical devices and apparatus.

In an embodiment, an article is provided. The article includes a heat-generating member. The article further includes a composition disposed on the heat-generating member, the composition comprising: an aromatic epoxy resin; a latent catalytic curing agent, the latent catalytic curing agent being active at a temperature that is from about 30° C. to about 300° C.; and a filler.

In another embodiment, an article is provided. The article includes a heat-generating component. The article further includes a heat-dissipating component disposed over a surface of the heat-generating component, the heat-dissipating component comprising a cured composition comprising an epoxy polymerization product of a curable composition, the curable composition comprising: about 20 wt % to about 70 wt % of an aromatic epoxy resin based on a total wt % of the curable composition; about 30 wt % to about 80 wt % of a filler based on the total wt % of the curable composition; and greater than 0 wt % and less than about 10 wt % of a latent catalytic curing agent, the total wt % of the curable composition not to exceed 100 wt %.

In another embodiment, a method of forming an article is provided. The method includes: positioning a curable composition in a mold, the curable composition comprising an aromatic epoxy resin, a latent catalytic curing agent, and a filler. The method further includes heating the mold and the curable composition to form a cured composition. The method further includes positioning the cured composition on a heat-generating component to form an article.

In another embodiment, a composition for thermal management is provided. The composition includes an aromatic epoxy resin, a latent catalytic curing agent, and a filler.

In another embodiment, a cured composition comprising an epoxy polymerization product of a curable composition is provided. The curable composition includes about 20 wt % to about 70 wt % of an aromatic epoxy resin based on a total wt % of the curable composition; about 30 wt % to about 80 wt % of a filler based on the total wt % of the curable composition; and greater than about 0 wt % and less than about 10 wt % of a latent catalytic curing agent, the total wt % of the curable composition not to exceed 100 wt %, the cured composition for covering at least a portion of a heat-generating device, heat-generating apparatus, or component thereof.

In another embodiment, a method of forming a cured composition for thermal management is provided. The method includes heating a curable composition at a first temperature, the curable composition comprising an aromatic epoxy resin, a latent catalytic curing agent, and a filler. The method further includes positioning the heated curable composition in a mold, and heating the mold and curable composition at a second temperature to form a cured composition, the first temperature and the second temperature being the same or different.

### DETAILED DESCRIPTION

Embodiments of the present disclosure generally relate to epoxy resin compositions, methods of making epoxy resin compositions, and to uses of epoxy resin compositions. Compositions described herein can be used for thermal management of various articles, apparatus, devices, or components thereof by removing heat generated by the apparatus, devices, or components thereof. “Thermal management” refers to the capability of keeping temperature-sensitive elements in or around an electronic/electrical article within a prescribed operating temperature in order to avoid failure. In some embodiments, the compositions are thermally conductive compositions. The term “thermally conductive” refers to the property of a material to transfer or pass thermal energy or heat to another element or itself.

Generally, the compositions can be used with a heat-generating member such as an electrical apparatus, electronic apparatus, an electrical device, electronic device, or a component thereof. For example, compositions (or cured compositions) described herein can contact, directly or indirectly, a heat-generating member such as an electric or an electronic part. Because the composition (or cured composition) is thermally conductive, the composition (or cured composition) can remove heat generated by the electric or electronic part.

The inventors have found new and improved compositions that are easy to use and has good thermal conductivity. Unlike conventional compositions for thermal management which are typically 2K systems requiring mixing on-site, embodiments described herein can be single component systems as polymerization does not occur prior to application of a stimulus such as heat. For example, compositions of the present disclosure can include an epoxy resin, a catalytic curing agent, a filler, and an optional additive. Upon application of a stimulus, such as heat, the latent catalytic curing agent causes, for example, polyaddition reactions to occur and resulting in coupling, cross-linking, or both, of the epoxy resin among other materials. The compositions can be curable compositions that can be stored under ambient conditions. Conventional compositions for thermal management lack such abilities as they are not single component systems.

Due to, for example, the thermal conductive properties of compositions described herein, compositions of the present disclosure can be used to remove or dissipate heat from a heat-generating element or member. Such heat-generating elements or members are present in, for example, electrical apparatus, electronic apparatus, electrical devices, and electronic devices. Accordingly, and in some embodiments, an article includes a heat-generating member and a composition of the present disclosure disposed on the heat generating member. The composition can be disposed on one or more surfaces and can contact the one or more surfaces directly or indirectly.

The use of headings is for purposes of convenience only and does not limit the scope of the present disclosure. Embodiments described herein can be combined with other embodiments.

As used herein, a “composition” can include component(s) of the composition, reaction product(s) of two or more components of the composition, a remainder balance of remaining starting component(s), or combinations thereof. Compositions of the present disclosure can be prepared by any suitable mixing process.

### Compositions

Embodiments of the present disclosure generally relate to compositions that can be used for thermal management of heat-generating devices, heat-generating apparatus, or a component thereof. For example, the compositions can be used as casting compositions (reaction compositions), molding compositions (reaction resin compositions), as prepregs, among other applications. The compositions can be used in electrical engineering, for example for sheathing electrical and electronic components such as capacitors, collectors, and resistors.

As described herein, the inventor has found compositions that have higher thermal conductivity than conventional compositions. In some embodiments, the compositions can be used for thermal management of various devices and apparatus. Here, the compositions can be used to dissipate heat from a heat-generating device, heat-generating apparatus, or a component thereof, such as electrical and electronic devices, apparatus, or components thereof, such as electric motors. In such a manner, the compositions can improve the reliability, performance, safety, and lifetime of devices and apparatus.

Compositions of the present disclosure can include an epoxy resin, a catalytic curing agent, and a filler. In some embodiments, the compositions can further include one or more additives. The total weight percent (total wt %) of the composition does not exceed 100 wt %. In at least one embodiment, a composition includes an epoxy resin comprising an aromatic epoxy resin; a latent catalytic curing agent, the latent catalytic curing agent being active at a temperature that is from about 30° C. to about 300° C.; and a filler.

The compositions can be curable compositions wherein the compositions can be cured by application of a stimulus, for example, a change in temperature.

Epoxy resins are those compounds containing at least one vicinal epoxy group. Epoxy resins can be monomeric or polymeric. The epoxy resin may be saturated or unsaturated, aliphatic, cycloaliphatic, aromatic or heterocyclic and may be substituted. In some examples, the choice of epoxy resin is based on, for example, the UV resistance properties desired.

The epoxy resin utilized may be, for example, an epoxy resin or a combination of epoxy resins prepared from an epihalohydrin and a phenol or a phenol type compound, prepared from an epihalohydrin and an amine, prepared from an epihalohydrin and an a carboxylic acid, or prepared from the oxidation of unsaturated compounds.

Suitable epoxy resins useful for embodiments described herein can include aromatic epoxy resins and non-aromatic epoxy resins. The epoxy resins can contain more than one and in some embodiments, two 1,2-epoxy groups per molecule. In some embodiments, the epoxy resin may be liquid rather than solid. In at least one embodiment, the epoxy resin has an epoxide equivalent weight of about 100 to about 5,000, such as from about 100 to about 2,000, such as from about 100 to 500, as determined by titration methods described in ASTM D1652.

In some embodiments, the epoxy resins may be non-aromatic hydrogenated cyclohexane dimethanol and diglycidyl ethers of hydrogenated Bisphenol A-type epoxy resin, such as hydrogenated bisphenol A-epichlorohydrin epoxy resin, cyclohexane dimethanol diglycidylether, and cycloaliphatic epoxy resin.

In at least one embodiment, the epoxy resins utilized include aromatic epoxy resins such as those resins produced from an epihalohydrin and a phenol or a phenol-type compound. The phenol-type compound includes compounds having an average of more than one aromatic hydroxyl group per molecule. Examples of phenol-type compounds include dihydroxy phenols, biphenols, bisphenols, halogenated biphenols, halogenated bisphenols, hydrogenated bisphenols, alkylated biphenols, alkylated bisphenols, trisphenols, phenol-aldehyde resins, novolac resins (the reaction product of phenols and simple aldehydes, such as formaldehyde), halogenated phenol-aldehyde novolac resins, substituted phenol-aldehyde novolac resins, phenol-hydrocarbon resins, substituted phenol-hydrocarbon resins, phenol-hydroxybenzaldehyde resins, alkylated phenol-hydroxybenzaldehyde resins, hydrocarbon-phenol resins, hydrocarbon-halogenated phenol resins, hydrocarbon-alkylated phenol resins, or combinations thereof.

In some embodiments, the epoxy resin utilized can include those resins produced from an epihalohydrin and bisphenols, halogenated bisphenols, hydrogenated bisphenols, novolac resins, and polyalkylene glycols, or combinations thereof.

In at least one embodiment, the epoxy resin utilized in compositions of the disclosure preferably include those resins produced from an epihalohydrin and resorcinol, catechol, hydroquinone, biphenol, bisphenol A, bisphenol AP (1,1-bis(4-hydroxyphenyl)-1-phenyl ethane), bisphenol F, bisphenol K, tetrabromobisphenol A, phenol-formaldehyde novolac resins, alkyl substituted phenol-formaldehyde resins, phenol-hydroxybenzaldehyde resins, cresol-hydroxybenzaldehyde resins, dicyclopentadiene-phenol resins, dicyclopentadiene-substituted phenol resins tetramethylbiphenol, tetramethyl-tetrabromobiphenol, tetramethyltribromobiphenol, tetrachlorobisphenol A, or combinations thereof.

In some embodiments, the epoxy resin utilized in compositions of the present disclosure include those resins produced from an epihalohydrin and an amine. Suitable amines include diaminodiphenylmethane, aminophenol, xylene diamine, anilines, and the like, or combinations thereof.

In at least one embodiment, the epoxy resin utilized in the compositions of the present disclosure can include those resins produced from an epihalohydrin and a carboxylic acid. Suitable carboxylic acids include phthalic acid, isophthalic acid, terephthalic acid, tetrahydrohydrophthalic acid, hexahydrophthalic acid, endomethylenetetrahydrophthalic acid, isophthalic acid, methylhexahydrophthalic acid, and the like or combinations thereof.

In some embodiments, the epoxy resin compounds utilized in the compositions of the disclosure include those resins produced from an epihalohydrin and compounds having at least one aliphatic hydroxyl group. In such embodiments, it is understood that such resin compositions produced contain an average of more than one aliphatic hydroxyl groups. Examples of compounds having at least one aliphatic hydroxyl group per molecule include aliphatic alcohols, aliphatic diols, polyether diols, polyether triols, polyether tetrols, any combination thereof and the like. Also suitable are the alkylene oxide adducts of compounds containing at least one aromatic hydroxyl group. In this embodiment, it is understood that such resin compositions produced contain an average of more than one aromatic hydroxyl groups. Examples of oxide adducts of compounds containing at least one aromatic hydroxyl group per molecule include ethylene oxide, propylene oxide, or butylene oxide adducts of dihydroxy phenols, biphenols, bisphenols, halogenated bisphenols, alkylated bisphenols, trisphenols, phenol-aldehyde novolac resins, halogenated phenol-aldehyde novolac resins, alkylated phenol-aldehyde novolac resins, hydrocarbon-phenol resins, hydrocarbon-halogenated phenol resins, or hydrocarbon-alkylated phenol resins, or combinations thereof.

The epoxy resin, in some embodiments, can refer to an advanced epoxy resin which is the reaction product of one or more epoxy resins components, as described above, with one or more phenol type compounds and/or one or more compounds having an average of more than one aliphatic hydroxyl group per molecule as described above. Alternatively, the epoxy resin may be reacted with a carboxyl substituted hydrocarbon. A carboxyl substituted hydrocarbon is described herein as a compound having a hydrocarbon backbone, such as a C₁-C₄₀ hydrocarbon backbone, and one or more carboxyl moieties, such as more than one, such as two. The C₁-C₄₀ hydrocarbon backbone may be a linear- or branched-chain alkane or alkene, optionally containing oxygen. Fatty acids and fatty acid dimers are among the useful carboxylic acid substituted hydrocarbons. Included in the fatty acids are caproic acid, caprylic acid, capric acid, octanoic acid, pivalic acid, neodecanoic acid, decanoic acid, lauric acid, myristic acid, palmitic acid, stearic acid, palmitoleic acid, oleic acid, linoleic acid, linolenic acid, erucic acid, pentadecanoic acid, margaric acid, arachidic acid, and dimers thereof.

In at least one embodiment, the epoxy resin is a reaction product of a polyepoxide and a compound containing more than one isocyanate moiety or a polyisocyanate. The epoxy resin produced in such a reaction can be an epoxy-terminated polyoxazolidone.

In some embodiments, the epoxy resin includes cyclohexanol, 4,4′-(1-methylethylidene)bis-, polymer with 2-(chloromethyl)oxirane (CAS Number 30583-72-3).

Examples of epoxy resins include epoxy resins of dihydroxy phenols, epoxy resins of biphenols, epoxy resins of bisphenols, epoxy resins of halogenated bisphenols, epoxy resins of alkylated bisphenols, epoxy resins of trisphenols, epoxy resins of phenol-aldehyde novolac resins, epoxy resins of halogenated phenol-aldehyde novolac resins, epoxy resins of alkylated phenol-aldehyde novolac resins, epoxy resins of hydrocarbon-phenol resins, epoxy resins of hydrocarbon-halogenated phenol resins, epoxy resins of hydrocarbon-alkylated phenol resins, or combinations thereof. Illustrative, but non-limiting examples of an epoxy resin include Epikote 1001 epoxy resin (epoxy resin based on bisphenol A), Epikote 1004 epoxy resin (epoxy resin based on bisphenol A), Epikote 1007 epoxy resin (epoxy resin based on bisphenol A), Epikote 1009 epoxy resin (epoxy resin based on bisphenol A) Epon SU8 epoxy resin (epoxidized bisphenol A novolac), Epon 1031 epoxy resin (epoxidized glyoxal-phenol novolac), Epon 1163 epoxy resin (epoxy resin based on tetrabromobisphenol A), Epikote 03243/LV epoxy resin (epoxy resin based on (3,4-epoxycyclohexyl)methyl 3,4-epoxycyclohexylcarboxylate and bisphenol A), Epon 164 epoxy resin (epoxidized o-cresol novolac)—all products commercially available from Hexion Inc.

In at least one embodiment, the aromatic epoxy resin can be selected from the group consisting of a difunctional bisphenol-A-diglycidyl-ether, a bisphenol-F-diglycidyl-ether, a tetra-glycidyl-methylene-dianiline, an epoxidized tetra-phenylethane, a derivative thereof, and combinations thereof. In some embodiments, the aromatic epoxy resin can be derived from bisphenol A, bisphenol F, tetraglycidyl-methylenedianiline, a halogenated bisphenol, a novolac, an ortho-aminophenol, a para-aminophenol, a flourenone bisphenol, a dicyclopentadiene, or combinations thereof.

Other illustrative, but non-limiting, examples of epoxy resins include Epikote 828LVEL epoxy resin (a difunctional bisphenol-A-diglycidyl-ether commercially available from Westlake Epoxy), Epikote 162 epoxy resin (a bisphenol-F-diglycidyl-ether commercially available from Westlake Epoxy), Epikote 158 epoxy resin (a bisphenol-F-diglycidyl-ether commercially available from Westlake Epoxy), Epikote 496 epoxy resin (a tetra-glycidyl-methylene-dianiline commercially available from Westlake Epoxy), Epikote 1031 epoxy resin (an epoxidized tetra-phenylethane commercially available from Westlake Epoxy).

In some embodiments, the epoxy resin can be selected to have as high aromatic content as possible. For example, the epoxy resin can include aromatic epoxy resins, such as epoxy resins that include phenols, phenyls, combinations thereof, or other aromatic moieties. The higher aromatic content can provide increased thermal conductivity of the composition.

In at least one embodiment, the aromatic epoxy resin can have an aromatic content of about 30 wt % to about 70 wt %, such as from about 40 wt % to about 60 wt %, such as from about 40 wt % to about 55 wt % based on the total weight % of the aromatic epoxy resin. In some embodiments, an aromatic content (wt %) in the aromatic epoxy resin, based on the wt % of the aromatic epoxy resin, can be 30, 35, 40, 45, 50, 55, 60, 65, or 70, or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other amounts of epoxy resin(s) are contemplated.

The aromatic content of the aromatic epoxy resin is calculated based on the molar weight of the aromatic structure (C₆H₄=76 g/mol) multiplied by the number of aromatic rings of the aromatic epoxy resin and the result is then divided by the total molecular weight of the aromatic epoxy resin.

Combinations or blends, in any suitable proportions, of polymers based on an epoxide compound can be utilized for compositions described herein.

A total amount of epoxy resin(s) in compositions described herein can be from about 20 weight percent (wt %) to about 70 wt %, such as from about 25 wt % to about 65 wt %, such as from about 30 wt % to about 60 wt %, such as from about 35 wt % to about 55 wt %, such as from about 40 wt % to about 50 wt %, based on a total wt % of the composition. In some embodiments, a total amount (wt %) of epoxy resin(s) in compositions described herein, based on the total wt % of the composition, can be 20, 25, 30, 35, 40, 45, 50, 55, 60, 65, or 70, or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other amounts of epoxy resin(s) are contemplated.

The compositions described herein further include a catalytic curing agent. The catalytic curing agent can be a latent catalytic curing agent (also called a “latent catalyst”). Latent catalytic curing agents can allow for control over the onset of polymerization and simplified operation. For example, use of latent catalysts avoids in-situ addition of chemicals that may be highly reactive and mixing problems. Latent catalysts can be stored together without premature reaction, thereby enabling the use of single component formulations that are ready to polymerize by application of an appropriate stimulus. The latent catalytic curing agents become active in response to temperatures above ambient temperatures, as further described below.

When a latent catalytic curing agent is described as being “active” at a selected temperature or temperature range, the term “active” refers to the latent catalytic curing agent causing reactions (for example, polyadditions) to occur between one or more components of the composition when the temperature is set to the selected temperature or temperature range.

The stimulant, such as heat, acts on materials of the composition (for example, the latent catalytic curing agent). Upon application of the stimulus, the latent catalytic curing agent causes polyaddition reactions to occur and resulting in coupling, cross-linking, or both, of the epoxy resin among other materials.

Conventional compositions for thermal management typically utilize catalytic curing agents that are not latent, for example, that initiate cure at ambient temperatures and can quickly cause increased formulation viscosity. As a result, such conventional compositions are made from a 2K system where two or more components are required to be mixed on site. In contrast, compositions described herein can be single component systems (1K systems) as polymerization does not occur prior to application of a stimulus, for example, heat. 1K systems already comprise all of the necessary ingredients and are stable in storage. It is also contemplated that compositions described herein are suitable as a storable component for a 2K system or other multi-component system.

Suitable latent catalytic curing agents (also called “latent catalysts”) can include an imidazole, a substituted imidazole, an imidazole adduct, an imidazole complex (for example, Ni-imidazole complex), a tertiary amine, a quaternary ammonium compound, a quaternary phosphonium compound, a dicyandiamide, a salicylic acid, urea, a urea derivative, a boron trifluoride complex, a boron trichloride complex (for example, boron trichloride alkylalmine complex, an epoxy addition reaction product, a tetraphenylene-boron complex, an amine borate, a metal halide, an amine titanate, a metal acetylacetonate, a naphthenic acid metal salt, an octanoic acid metal salt, other metal salts, metal chelates, or combinations thereof. Latent catalytic curing agents can include, for example, boron trichloride dimethyloctylamine complex (CAS No. 34762-90-8), oligomeric polyethylenepiperazines, bis-(dimethylaminopropyl)-amino-2-propanol, N,N′-bis-(3-dimethylaminopropyl)urea, N-(2-hydroxypropyl)imidazole, dimethyl-2-(2-aminoethoxy)ethanol, bis(2-dimethylaminoethyl) ether, pentamethyldiethylenetriamine, dimorpholinodiethyl ether, 1,8-diazobicyclo[5.4.0]undec-7-ene (DBU) (CAS No. 6674-22-2), N-methylimidazole (also known as 1-methylimidazole (CAS No. 616-47-7)), 1,2-dimethylimidazole, triethylenediamine, 1,1,3,3-tetra-methylguanidine, tin(IV) chloride, tin octoate, or combinations thereof.

In some examples, the latent catalytic curing agent is anhydride, acid anhydride free, or combinations thereof. Anhydrides and acid anhydrides can be a concern due to their respiratory-sensitizing effects.

Suitable latent catalytic curing agents can include a sulfonium salt of formula (I), a sulfonium salt of formula (II), a sulfonium salt of formula (III), a sulfonium salt of formula (IV), or combinations thereof:

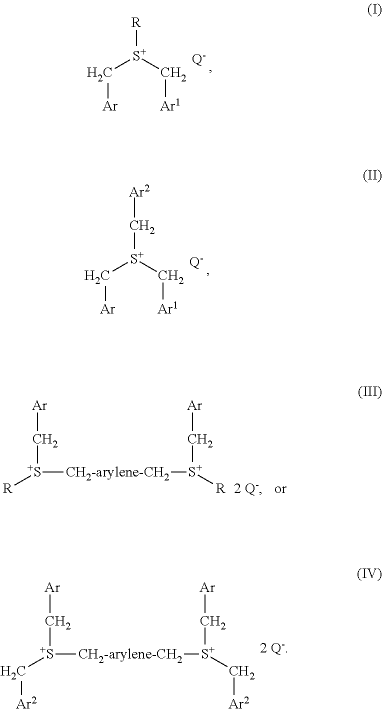

In each of formulas (I)-(IV), each R group can be an unsubstituted hydrocarbyl, a substituted hydrocarbyl, or a functional group comprising at least one element from Group 13-17 of the periodic table of the elements. When an R group is a functional group comprising at least one element from Group 13-17, the R group can be halogen (F, Cl, Br, or I), O, N, Se, Te, P, As, Sb, S, B, Si, Ge, Sn, Pb, and the like, such as C(O)R*, C(C)NR*₂, C(O)OR*, NR*₂, OR*, SeR*, TeR*, PR*₂, AsR*₂, SbR*₂, SR*, SOₓ (where x=2 or 3), BR*₂, SiR*₃, GeR*₃, SnR*₃, PbR*₃, and the like, where R* can be, independently, hydrogen or unsubstituted hydrocarbyl, or where at least one heteroatom has been inserted within the unsubstituted hydrocarbyl.

An “unsubstituted hydrocarbyl” refers to a group that consists of hydrogen and carbon atoms only. Non-limiting examples of unsubstituted hydrocarbyl include an alkyl group having from 1 to 20 carbon atoms such as methyl, ethyl, n-propyl, isopropyl, n-butyl, iso-butyl, sec-butyl, and tert-butyl, pentyl, hexyl, heptyl, octyl, ethyl-2-hexyl, isooctyl, nonyl, n-decyl, isodecyl, or isomers thereof; a cycloaliphatic group having from 3 to 20 carbon atoms such as, for example, cyclopentyl or cyclohexyl; an aromatic group having from 6 to 20 carbon atoms such as, for example, phenyl or naphthyl; or any combination thereof. Any of the foregoing numbers can be used singly to describe an open-ended range or in combination to describe a close-ended range.

A “substituted hydrocarbyl” refers to an unsubstituted hydrocarbyl in which at least one hydrogen of the unsubstituted hydrocarbyl has been substituted with at least one heteroatom or heteroatom-containing group, such as one or more elements from Group 13-17 of the periodic table of the elements, such as halogen (F, Cl, Br, or I), O, N, Se, Te, P, As, Sb, S, B, Si, Ge, Sn, Pb, and the like, such as C(O)R*, C(C)NR*₂, C(O)OR*, NR*₂, OR*, SeR*, TeR*, PR*₂, AsR*₂, SbR*₂, SR*, SOₓ (where x=2 or 3), BR*₂, SiR*₃, GeR*₃, SnR*₃, PbR*₃, and the like, where R* is, independently, hydrogen or unsubstituted hydrocarbyl, or where at least one heteroatom has been inserted within the unsubstituted hydrocarbyl.

In each of formulas (I)-(IV), each R group can have, independently, any suitable number of carbon atoms such as from 1 to 20 carbon atoms, such as from 1 to 12 carbon atoms, such as from 1 to 10 carbon atoms, such as from 1 to 8 carbon atoms, such as from 1 to 5 carbon atoms, 1 to 4 carbon atoms, or from 3 to 8 carbon atoms. In some embodiments, the number of carbon atoms in each R group of formulas (I)-(IV) can be, independently, 1, 2, 3, 4, 5, 6, 7, 8, 9, 10, 11, 12, 13, 14, 15, 16, 17, 18, 19, or 20. Each of the foregoing numbers can be preceded by the word “about,” “at least about,” “less than about,” or “more than about,” and any of the foregoing numbers can be used singly to describe an open-ended range or in combination to describe a close-ended range. Each R group of formulas (I)-(IV) can be, independently, linear or branched, saturated or unsaturated, cyclic or acyclic, aromatic or not aromatic. Regarding saturation, each R group of formulas (I)-(IV) can be, independently, fully saturated, partially unsaturated, or fully unsaturated.

In some embodiments, each R group of formulas (I)-(IV) can be, independently, C1-C12 alkyl, C3-C8 cycloalkyl, C4-C10 cycloalkylalkyl, or phenyl which is unsubstituted or monosubstituted or polysubstituted by C1-C8 alkyl, C1-C4 alkoxy, halogen, hydroxyl, nitro, phenyl, phenoxy, alkoxycarbonyl having 1-4 carbon atoms, or acyl having 1-12 carbon atoms.

In some embodiments, each of Ar, Ar¹, or Ar² of formulas (I)-(IV) are aromatic. Each of Ar, Ar¹, or Ar² of formulas (I)-(IV) can be, independently, monocyclic, polycyclic, or heterocyclic, and unsubstituted or substituted. In at least one embodiment, and when substituted, the monocyclic, polycyclic, or heterocyclic ring can be independently, substituted (monosubstituted or polysubstituted) with one or more R groups such as those described above.

In some examples, each of Ar, Ar¹, or Ar² of formulas (I)-(IV) can be, independently, phenyl, naphthyl, or fluorenyl, where the phenyl, naphthyl, or fluorenyl is unsubstituted or monosubstituted or polysubstituted by C1-C8 alkyl, C1-C4 alkoxy, halogen, hydroxyl, nitro, phenyl, phenoxy, alkoxycarbonyl having 1-4 carbon atoms, or acyl having 1-12 carbon atoms.

In some embodiments, each arylene of formulas (I)-(IV) is aromatic. In at least one embodiment, each arylene of formulas (I)-(IV) can be, independently, monocyclic, polycyclic, or heterocyclic, and unsubstituted or substituted. In some examples, and when substituted, the monocyclic, polycyclic, or heterocyclic ring can be independently, substituted (monosubstituted or polysubstituted) with one or more R groups such as those described above. In some embodiments, each arylene of formulas (I)-(IV) can be, independently, phenylene, naphthylene, fluorenylene, where the phenylene, naphthylene, or fluorenylene is unsubstituted or monosubstituted or polysubstituted by C1-C8 alkyl, C1-C4 alkoxy, halogen, hydroxyl, nitro, phenyl, phenoxy, alkoxycarbonyl having 1-4 carbon atoms, or acyl having 1-12 carbon atoms.

In some embodiments, each Q⁻ of formulas (I)-(IV) is a counterion. The counterion can have the formula MX⁻, where M is a metal or metalloid, and X is a group comprising at least one element from Group 13-17, such as halogen (F, Cl, Br, or I), O, N, P, S, B, Si, among others. Illustrative, but non-limiting, examples of M can include antimony (Sb), silver (Ag), among other metals or metalloids. Illustrative, but non-limiting, examples of X can include fluorine (F), hydroxyl (OH), and combinations thereof. Examples of Q⁻ can include, but are not limited to SbF₆⁻, AsF₆⁻, or SbF₅OH⁻.

In formulas (I) and (II), only one counterion is present as indicated by Q⁻. In formulas (III) and (IV), two counterions are present as indicated by 2 Q⁻.

In each of formulas (I)-(IV), when more than one R is present, each R can be the same or different. In each of formulas (I)-(IV), when more than one Ar, Ar¹, or Ar² is present, each of Ar, Ar¹, or Ar² can be the same or different. In each of formulas (I)-(IV), when more than one Q⁻ is present, each Q⁻ can be the same or different.

In at least one embodiment, the latent catalytic curing agent is selected from the group consisting of a sulfonium salt of formula (I), a sulfonium salt of formula (II), a sulfonium salt of formula (III), a sulfonium salt of formula (IV), and combinations thereof. In these and other embodiments, each R group of formulas (I)-(IV) is, independently, C1-C12 alkyl, C3-C8 cycloalkyl, C4-C10 cycloalkylalkyl, or phenyl which is unsubstituted or monosubstituted or polysubstituted by C1-C8 alkyl, C1-C4 alkoxy, halogen, hydroxyl, nitro, phenyl, phenoxy, alkoxycarbonyl having 1-4 carbon atoms, or acyl having 1-12 carbon atoms; each of Ar, Ar¹, Ar², or combinations thereof, of formulas (I)-(IV) is, independently, phenyl, naphthyl, or fluorenyl, where the phenyl, naphthyl, or fluorenyl is unsubstituted or monosubstituted or polysubstituted by C1-C8 alkyl, C1-C4 alkoxy, halogen, hydroxyl, nitro, phenyl, phenoxy, alkoxycarbonyl having 1-4 carbon atoms, or acyl having 1-12 carbon atoms; each arylene of formulas (III) and (IV) is, independently, phenylene, naphthylene, fluorenylene, where the phenylene, naphthylene, or fluorenylene is unsubstituted or monosubstituted or polysubstituted by C1-C8 alkyl, C1-C4 alkoxy, halogen, hydroxyl, nitro, phenyl, phenoxy, alkoxycarbonyl having 1-4 carbon atoms, or acyl having 1-12 carbon atoms; and each Q⁻ of formulas (I)-(IV) is, independently, SbF₆⁻, AsF₆⁻, or SbF₅OH^{-.}

Combinations or blends, in any suitable proportions, of latent catalytic curing agents can be utilized for compositions described herein.

A total amount of latent catalytic curing agent(s) in compositions described herein can be more than 0 wt %, less than 10 wt %, or combinations thereof, such as from about 0.1 wt % to about 3 wt %, such as from about 0.05 wt % to about 1.5 wt %, such as from about 0.1 wt % to about 1 wt %, such as from about 0.2 wt % to about 0.9 wt %, such as from about 0.3 wt % to about 0.8 wt %, such as from about 0.4 wt % to about 0.7 wt %, such as from about 0.5 wt % to about 0.6 wt %, based on the total wt % of the composition. In some embodiments, a total amount (wt %) of latent catalytic curing agent(s) in compositions described herein, based on the total wt % of the composition, can be 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.8, 1.9, 2, 2.1, 2.2, 2.3, 2.4, 2.5, 2.6, 2.7, 2.8, 2.9, or 3, 4, 5, 6, 7, 8, 9, 10 or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other amounts of latent catalytic curing agent(s) are contemplated.

Compositions described herein can further include a fillers that are thermally conductive, such as fillers having a thermal conductivity of about 0.5 W/mK or more (W/mK is Watts conducted per meter thickness, per degree Kelvin), about 400 W/mK or less, or combinations thereof. In some embodiments, the filler can be a material having a thermal conductivity that is from about 0.5 W/mK to about 400 W/mK, such as from about 1 W/mK to about 100 W/mK, such as from about 10 W/mK to about 50 W/mK. In some examples, the thermal conductivity of a filler (in W/mK) can have a low of about 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, or 15 to a high of about 400, 350, 300, 250, 200, 150, 100, 90, 80, 70, 60, 50, 40, 30, 20, or 15. Other thermal conductivities of the filler are contemplated. Each of the foregoing numbers can be preceded by the word “about,” “at least about,” “less than about,” or “more than about,” and any of the foregoing numbers can be used singly to describe an open-ended range or in combination to describe a close-ended range. Here, for example, the thermal conductivity of a filler can be more than about 2 W/mK, less than about 100 W/mK, about 50 W/mK or more, about 10 W/mK or less, from about 0.5 to about 10 W/mK, or from about 30 W/mK to about 50 W/mK.

Illustrative, but non-limiting examples of fillers include silica, wollastonite (CaSiO₃ that may contain small amounts of iron, magnesium, and manganese), quartz, alumina, aluminum nitride (AlN), boron nitride (BN), silicon nitride (SiN), silicon carbide (SiC), beryllium oxide (BeO), and combinations thereof. Ceramic materials, in general, can be used. Other fillers are contemplated. In some embodiments, if insulation properties can be secured, application of carbon fillers such as graphite can also be considered.

In some examples, the filler can include an epoxy-silane pre-treated material, such as an epoxy-silane pre-treated version of the aforementioned fillers, such as epoxy-silane pre-treated silica, epoxy-silane pre-treated wollastonite, or combinations thereof. An illustrative, but non-limiting, example of an epoxysilane pre-treated silica filler is Millisil W12 EST commercially available from Quarzwerke Group. An illustrative, but non-limiting, example of an epoxysilane pre-treated wollastonite filler is Tremin 283-100 EST commercially available from Quarzwerke Group.

In at least one embodiment, the filler is selected from the group consisting of silica, wollastonite, quartz, alumina, aluminum nitride, boron nitride, silicon nitride, silicon carbide, beryllium oxide, epoxy-silane pre-treated silica, epoxy-silane pre-treated wollastonite, and combinations thereof.

Fillers can be of various particle diameters. In some embodiments, the filler can have a D50 particle diameter such as from about 1 μm to about 100 μm, such as about 35 μm or more, or from about 15 μm to about 30 μm, or from about 1 μm to about 4 μm. In at least one embodiment, the D50 particle diameter of the filler can be in a range from about 35 μm to 80 μm, such as from about 40 μm to about 70 μm, such as from about 45 μm to about 60 μm. Additionally, or alternatively, the D50 particle diameter of the filler can be in a range from about 15 μm to about 25 μm, such as from about 15 μm to about 20 μm or from about 20 μm to about 25 μm. Additionally, or alternatively, the D50 particle diameter of the filler can be in a range from about 1 μm to about 3 μm, such as from about 1 μm to about 2 μm or from about 2 μm to about 3 μm. Other D50 particle diameters are contemplated. The D50 particle diameter is a particle diameter (median diameter) at 50% of accumulation of particle size distribution on a mass basis, which means a particle diameter at the point where the cumulative value becomes 50% in the cumulative curve that the particle size distribution is obtained on a mass basis and the whole mass is set to 100%. Such a D50 particle diameter can be measured by laser diffraction. Laser diffraction can be accomplished by using a MASTERSIZER3000 instrument from Marvern Inc., based on ISO-13320 standard, with ethanol as a solvent. The incident laser is scattered by the particles dispersed in the solvent, and the intensity and the directional value of the scattered laser vary depending on the size of the particles, which are analyzed using the Mie theory. Through the above analysis, the particle diameter can be evaluated by obtaining the distribution through conversion to the diameter of a sphere having the same volume as that of the dispersed particle and obtaining the D50 value as the median value of the distribution through that.

The filler can have any suitable shape. The choice of the shape of the filler can be based on, for example, insulation, filling effect, dispersibility, viscosity of the resin composition, thixotropy of the resin composition, settling possibility in the composition, desired thermal resistance, desired thermal conductivity, combinations thereof, among other reasons. Shapes of the filler include spherical fillers, substantially spherical fillers, non-spherical fillers (for example, needle shape, plate shape, among others), or combinations thereof.

Combinations or blends, in any suitable proportions, of fillers can be utilized for compositions described herein. Such combinations can include more than one type of filler (for example, silica and epoxysilane pre-treated silica), more than one size of filler (for example, silicon carbide having a D50 particle diameter of about 1.5 μm to about 4 μm and a silicon carbide having a D50 particle diameter of about 20 μm to about 35 μm), more than one shape (for example, spherical and needle shape), or combinations thereof.

A total amount of filler(s) in compositions described herein can be from about 30 wt % to about 80 wt %, such as from about 30 wt % to about 70 wt %, such as from about 40 wt % to about 60 wt %, such as from about 45 wt % to about 55 wt % based on a total wt % of the composition. Other amounts are contemplated. In some embodiments, a total amount (wt %) of filler(s) in compositions described herein, based on the total wt % of the composition, can be 30, 35 40, 45, 50, 55, 60, 65, 70, 75, or 80, or ranges thereof. Each of the foregoing numbers can be preceded by the word “about,” “at least about,” “less than about,” or “more than about,” and any of the foregoing numbers can be used singly to describe an open-ended range or in combination to describe a close-ended range.

A weight ratio of a total amount of epoxy resin to a total amount of filler in compositions described herein can be any suitable ratio or range. In some examples, a weight ratio of a total amount of epoxy resin to a total amount of filler in compositions described herein can be from about 1:10 to about 10:1, such as from about 1:8 to about 8:1, such as from about 1:5 to about 5:1, such as from about 1:3 to about 3:1, such as from about 1:2.5 to about 2.5:1, such as from about 1:2 to about 2:1, such as from about 1:1.5 to about 1.5:1. In at least one embodiment, a weight ratio of the total amount of epoxy resin to a total amount of filler in compositions described herein can be 1:10, 1:9.5, 1:9, 1:8.5, 1:8, 1:7.5, 1:7, 1:6.5, 1:6, 1:5.5, 1:5, 1:4.5, 1:4, 1:3.9, 1:3.8, 1:3.7, 1:3.6, 1:3.5, 1:3.4, 1:3.3, 1:3.2, 1:3.1, 1:3, 1:2.9, 1:2.8, 1:2.7, 1:2.6, 1:2.5, 1:2.4, 1:2.3, 1:2.2, 1:2.1, 1:2, 1:1.9, 1:1.8, 1:1.7, 1:1.6, 1:1.5, 1:1.4, 1:1.3, 1:1.2, 1:1.1, 1:1, 1.1:1, 1.2:1, 1.3:1, 1.4:1, 1.5:1, 1.6:1, 1.7:1, 1.8:1, 1.9:1, 2:1, 2.1:1, 2.2:1, 2.3:1, 2.4:1, 2.5:1, 2.6:1, 2.7: 1, 2.8:1, 2.9:1, 3:1, 3.1: 1, 3.2: 1, 3.3:1, 3.4:1, 3.5:1, 3.6:1, 3.7:1, 3.8:1, 3.9:1, 4:1, 4.5:1, 5:1, 5.5:1, 6:1, 6.5:1, 7:1, 7.5:1, 8:1, 8.5:1, 9:1, 9.5:1, or 10:1, or ranges thereof, though other weight ratios are contemplated.

Besides the epoxy resin, the latent catalytic curing agent, and the filler, compositions described herein can optionally include additives. Illustrative, but non-limiting, examples of optional additives can include, or are selected from the group consisting of a modifier (such as an alcohol or polyol), a block copolymer, an anti-foam agent, an anti-settling agent, an air-release agent, a pigment, an ultraviolet stabilizer (UV stabilizer), or combinations thereof. The additives can be used to aid in processing, to improve fracture toughness, among other uses.

In some embodiments, a total amount of additive(s) in compositions described herein can be from about 0 wt % to about 10 wt %, such as from about 0.01 wt % to about 10 wt %, such as from about 0.1 wt % to about 9 wt %, such as from about 0.5 wt % to about 7 wt %, such as from about 1 wt % to about 5 wt %, such as from about 2 wt % to about 3 wt %, based on the total wt % of the composition. Other amounts are contemplated.

Suitable modifiers of the composition include alcohols (also known as monohydric alcohols), polyols (also known as polyhydric alcohols), or combinations thereof. Suitable polyols include, but are not limited to glycols (dihydric alcohols (diols)) which can be derived from ethylene glycol, such as, for example, ethylene glycol, propylene glycol, methyl glycol, trimethylene glycol, neopentyl glycol, diethylene glycol, triethylene glycol, polyethylene glycol, polypropylene glycol, sugar compounds or compositions thereof. Trivalent or higher valent alcohols can also be used, such as, for example, glycerol, trimethylolpropane, glucose, other sugar compounds, or combinations thereof. Other alcohols and polyols are contemplated. In some examples, compositions described herein include a polyol such as glycols, such as ethylene glycol, propylene glycol, polyethylene glycol, polypropylene glycol, glycerols, a sugar compound, or combinations thereof. A non-limiting example of a glycol can include Heloxy PF, which is propylene glycol with a weight average molecular weight (Mw) of 400 g/mol. In at least one embodiment, compositions described herein can include a modifier, wherein the modifier is a polyhydric alcohol.

In some embodiments, a total amount of modifier(s) in compositions described herein can be from about 0 wt % to about 10 wt %, such as from about 0.05 wt % to about 8 wt %, such as from about 0.05 wt % to about 2 wt %, based on the total wt % of the composition. In at least one embodiment, the total amount (in wt %) of modifier(s) in a composition, based on the total wt % of the composition, can be 0, 0.01, 0.03, 0.05, 0.1, 0.25, 0.5, 0.75, 1, 1.5, 2, 2.5, 3, 3.5, 4, 4.5, 5, 5.5, 6, 6.5, 7, 7.5, 8, 8.5, 9, 9.5, or 10, or ranges thereof, though other amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

Suitable block copolymers include functionalized silicones, silicone-containing block copolymers, and combinations thereof. For example, a block copolymer with silicone and organic blocks (the organic blocks, for example being based on caprolactone or other lactones), such as Genioperl W35 (Wacker Chemie AG, Munich, Germany), can be utilized. The block copolymer can serve to improve fracture toughness.

Illustrative, but non-limiting, examples of anti-foam agents can include FC-402 (which includes tall oil fatty acids, glycols, and Si-containing materials, and is commercially available from Enterprise Specialty Products); Byk-037 (a volatiles-free, silicone-containing anti-foam agent commercially available from BYK-Chemie GmbH); Surfynol 104H (a multifunctional surfactant commercially available from Evonik Industries AG), or combinations thereof.

In some embodiments, a total amount of anti-foam agent(s) in compositions described herein can be from about 0 wt % to about 10 wt %, such as from about 0.05 wt % to about 8 wt %, such as from about 0.05 wt % to about 2 wt %, based on the total wt % of the composition. In at least one embodiment, the total amount (in wt %) of anti-foam agent(s) in a composition, based on the total wt % of the composition, can be 0, 0.01, 0.03, 0.05, 0.1, 0.25, 0.5, 0.75, 1, 1.5, 2, 2.5, 3, 3.5, 4, 4.5, 5, 5.5, 6, 6.5, 7, 7.5, 8, 8.5, 9, 9.5, or 10, or ranges thereof, though other amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

Anti-settling agents can reduce the settling behavior of various components in the composition. Illustrative, but non-limiting, examples of anti-settling agents include Byk 430, Byk 410, Byk 411, Byk 431, each of which are commercially available from BYK-Chemie GmbH. Combinations of anti-settling agents can be used. In some embodiments, a total amount of anti-settling agent(s) in compositions described herein can be from about 0 wt % to about 10 wt %, such as from about 0.05 wt % to about 8 wt %, such as from about 0.05 wt % to about 2 wt %, based on the total wt % of the composition. In at least one embodiment, the total amount (in wt %) of anti-foam agent(s) in a composition, based on the total wt % of the composition, can be 0, 0.01, 0.03, 0.05, 0.1, 0.25, 0.5, 0.75, 1, 1.5, 2, 2.5, 3, 3.5, 4, 4.5, 5, 5.5, 6, 6.5, 7, 7.5, 8, 8.5, 9, 9.5, or 10, or ranges thereof, though other amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

Air-release agents can reduce the amount of bubbling in the compositions (for example, to remove gaseous impurities). Illustrative, but non-limiting, examples of air-release agents include Byk S732, Byk-A 500, Byk-A 50, Byk-A 515, Byk 390, Byk 306, Byk 315, and Byk 356, each of which are commercially available from BYK-Chemie GmbH. Combinations of anti-settling agents can be used.

Illustrative, but non-limiting, examples of pigments can include magnesium oxide (commercially available from Sigma Aldrich), iron oxide of various oxidation states (commercially available from Lanxess AG), titanium oxide (commercially available from Sigma Aldrich), aluminum oxide (commercially available from Sigma-Aldrich), titanium dioxide (such as Ti-Pure 901/900 commercially available from Chemours), or combinations thereof. Combinations of pigments can be used. In some embodiments, a total amount of pigment(s) in compositions described herein can be from about 0 wt % to about 10 wt %, such as from about 0.05 wt % to about 8 wt %, such as from about 0.05 wt % to about 2 wt %, based on the total wt % of the composition. In at least one embodiment, the total amount (in wt %) of pigment(s) in a composition, based on the total wt % of the composition, can be 0, 0.01, 0.03, 0.05, 0.1, 0.25, 0.5, 0.75, 1, 1.5, 2, 2.5, 3, 3.5, 4, 4.5, 5, 5.5, 6, 6.5, 7, 7.5, 8, 8.5, 9, 9.5, or 10, or ranges thereof, though other amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

In some embodiments, compositions described herein can further comprise an additive, the additive selected from the group consisting of a modifier, a block copolymer comprising a functionalized silicone, a silicone-containing block copolymer, an anti-foam agent, an anti-settling agent, an air-release agent, a pigment, an ultraviolet stabilizer (UV stabilizer), and combinations thereof. In these and other embodiments, an amount of the additive in compositions described herein can be greater than 0 wt % and less than about 10 wt % based on the total wt % of the curable composition.

In at least one embodiment, compositions described herein can include about 20 wt % to about 70 wt % of the aromatic epoxy resin based on a total wt % of the composition; about 30 wt % to about 80 wt % of the filler based on the total wt % of the composition; and greater than 0 wt % and less than about 10 wt % of the latent catalytic curing agent, the total wt % of the composition not to exceed 100 wt %. In some embodiments, compositions described herein can further include a polyhydric alcohol, such as, for example, a polyhydric alcohol selected from the group consisting of ethylene glycol, propylene glycol, polyethylene glycol, polypropylene glycol, glycerols, a sugar compound, and combinations thereof. In at least one embodiment, a latent catalytic curing agent that can be used with compositions described herein is a latent catalytic curing agent that is active at a temperature that is from about 30° C. to about 300° C., such as from about 50° C. to about 275° C.

As described herein, the composition is stable at ambient conditions or different than ambient conditions due to, for example, the use of a latent catalytic curing agent. In contrast, conventional compositions for thermal management are typically two component systems where resin components and curative components must be mixed on-site and immediately prior to use.

At ambient conditions (for example, room temperature (about 20° C. to about 25° C.)), compositions described herein can be in the form of a fluid, paste, or a viscous substance. If the composition is to be curable, there are no limitations with regard to a method that can be used for curing the composition.

### Methods

Embodiments described herein also generally relate to methods of making or forming the compositions. Conventional compositions for thermal management are typically made using a two component system (for example, resin components and curative components), where upon mixing the two components, the composition is formed. After mixing, the mixture is neat cast into pre-heated molds.

In contrast, compositions described herein can be a single component system. The composition is heated prior to casting, then injected into a mold for casting. Unlike conventional compositions, compositions described herein can include a latent catalytic curing agent that will not polymerize the epoxy resin until application of a stimulus.

In general, compositions described herein can be made or formed by introducing the materials (the epoxy resin, the catalytic curing agent, the filler, and optional additives) of the composition to one another and mixing the materials.

The epoxy resin, the latent catalytic curing agent, the filler, and optional additives can be charged to a vessel and stirred, mixed, or otherwise agitated under mixing conditions effective to form a composition. Mixing conditions can include using a mixing pressure of about 10 mbar (˜1,000 Pa) to about 1,000 mbar (100,000 Pa), such as from about 20 mbar (˜2,000 Pa) to about 500 mbar (˜50,000 Pa), such as from about 30 mbar (3,000 Pa) to about 150 mbar (˜15,000 Pa), such as from about 40 mbar (˜4,000 Pa) to about 70 mbar (˜7,000 Pa), such as about 50 mbar (˜5,000 Pa), though other pressures are contemplated. In some examples, mixing conditions can include a mixing pressure (in Pa) of about 1,000, 2,000, 3,000, 4,000, 5,000, 6,000, 7,000, 8,000, 9,000, or 10,000, or ranges thereof, though other pressures are contemplated. Each of the foregoing numbers can be preceded by the word “about,” “at least about,” “less than about,” or “more than about,” and any of the foregoing numbers can be used singly to describe an open-ended range or in combination to describe a close-ended range.

Mixing conditions can include elevated temperature if desired. However, if elevated temperatures are used during mixing of the materials, the mixing temperature should be below the temperature at which the latent catalytic curing agent becomes active.

Mixing conditions can include stirring, mixing, agitating, or combinations thereof by using suitable devices such as a mechanical stirrer. Such mixing conditions can include use of suitable devices such as a mechanical stirrer (for example, an overhead stirrer), magnetic stirrer (for example, placing a magnetic stir bar in the vessel above a magnetic stirrer), or other suitable devices. For example, a stirrer (having a blade or propeller) can be rotated by receiving rotational power from a stirring motor to stir the one or more materials at suitable rotation speeds. Mixing conditions can include utilizing a non-reactive gas, such as N₂, Ar, or combinations thereof. For example, a non-reactive gas can be introduced to one or more of the epoxy resin, the catalytic curing agent, the filler, and optional additives to degas various components or otherwise remove unwanted gases (for example, oxygen) from the mixture

Mixing conditions can include use of suitable devices such as a mechanical stirrer, a magnetic stirrer, or other suitable devices, as described above. For example, a stirrer (having a blade or propeller) can be rotated by receiving rotational power from a stirring motor to stir the one or more materials at suitable rotation speeds, such as from about 50 revolutions per minute (rpm) to about 1,500 rpm, such as from about 75 rpm to about 1,000 rpm, such as from about 100 rpm to about 900 rpm, such as from about 200 rpm to about 800 rpm, such as from about 300 rpm to about 700 rpm, such as from about 400 rpm to about 600 rpm, such as from about 450 rpm to about 550 rpm, such as about 500 rpm. Any of the foregoing numbers can be used singly to describe an open-ended range or in combination to describe a close-ended range. Other rotation speeds are contemplated and can be selected based on the ability to mix the components sufficiently. Mixing conditions can include mixing for any suitable period, such as from about 1 min to about 48 h, such as from about 5 min to about 24 h, such as from about 30 min to about 10 h, such as from about 1 h to about 5 h, such as from about 2 h to about 3 h, though other periods are contemplated. Any of the foregoing numbers can be used singly to describe an open-ended range or in combination to describe a close-ended range.

At this stage, the composition is formed and can be stored for immediate use, later use, or combinations thereof. In addition, and at this stage, the composition can be a curable composition such that the composition can be cured by application of a stimulus. The curable composition can be in the form of a liquid, paste, or gel. One or more of the materials of the curable composition can be dispersed or suspended, as particles.

In some embodiments, compositions described herein can be a curable composition. The curable composition can be a 1K system.

The stimulant, such as heat, acts on materials of the composition (for example, the latent catalytic curing agent). Upon application of the stimulus, the latent catalytic curing agent causes polyaddition reactions to occur and resulting in coupling, cross-linking, or both, of the epoxy resin among other materials. The composition also hardens.

The composition can be cured under conditions effective to cure the composition. As described above, the latent catalytic curing agent present in the composition becomes active in response to temperatures above ambient temperatures. The selected curing conditions depend on, for example, the temperature at which the latent catalytic curing agent causes reactions to occur that resulting in coupling, cross-linking, or both, of the epoxy resin among other materials. Such curing conditions can include heating the composition to a temperature that is higher than ambient temperature, such as from about 30° C. to about 300° C., such as from about 40° C. to about 285° C., such as from about 50° C. to about 275° C., such as from about 75° C. to about 250° C., such as from about 100° C. to about 225° C., such as from about 125° C. to about 200° C., such as from about 150° C. to about 175° C., though other temperatures are contemplated. Any of the foregoing numbers can be used singly to describe an open-ended range or in combination to describe a close-ended range.

Curing conditions can include curing for any suitable amount of time, such as from about 1 min to about 48 h, such as from about 5 min to about 24 h, such as from about 30 min to about 10 h, such as from about 1 h to about 5 h, such as from about 2 h to about 3 h, though other periods are contemplated. Any of the foregoing numbers can be used singly to describe an open-ended range or in combination to describe a close-ended range. Curing can be performed in stages, such as cure cycles. For example, a cure cycle can include curing the composition at a first temperature at a first time; raising the temperature at a selected heating rate to a second temperature; and curing the composition at a second temperature for a second time. As a non-limiting example, the cure cycle can have the following profile: curing the composition at about 100° C. for about 2 hours, raising the temperature to about 190° C. (at a rate of about 1° C./min to about 10° C./min); and then curing the composition at about 190° C. for about 3 hours. Other cures or cure cycles are contemplated.

If desired, the composition can be introduced to a mold prior to curing. That is, the curable composition can be shaped (for example, molded) into any suitable shape. Depending on the application for which the composition is to be used, corresponding shaping of the mixture that is produced can be carried out. Curing can then take place at a selected temperature or temperature range depending on the temperature at which the latent catalytic curing agent used becomes active. The cured composition may then be positioned on a heat-generating device, heat-generating apparatus, or a component thereof.

In some embodiments, a composition can include a reaction product of a mixture comprising an epoxy resin, a catalytic curing agent, a filler, and optional additives.

Compositions of the present disclosure have excellent thermal conductivity. In some embodiments, the composition has a thermal conductivity that can be about 0.4 W/mK or more, about 5.0 W/mK or less, or combinations thereof. In some examples, the composition has a thermal conductivity that can be from about 0.5 W/mK to about 3.0 W/mK, such as from about 0.5 W/mK to about 2.0 W/mK, such as from about 1.0 W/mK to about 1.5 W/mK. In at least one embodiment, the thermal conductivity of a composition described herein can be 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, or 5.0, or ranges thereof, though other thermal conductivities are contemplated. Each of the foregoing numbers can be preceded by the word “about,” “at least about,” “less than about,” or “more than about,” and any of the foregoing numbers can be used singly to describe an open-ended range or in combination to describe a close-ended range.

### Uses

Embodiments of the present disclosure also generally relate to uses of the compositions described herein. Compositions described herein can be used for thermal management of various apparatus, devices, or components thereof. Generally, the compositions can be used with a heat-generating member such as an electrical or electronic apparatus, an electrical or electronic apparatus device, or a component thereof. For example, the cured composition (or cured product) can contact, directly or indirectly, an electric or an electronic part. Because the cured composition is thermally conductive, the cured composition can remove heat generated by the electric or electronic part. The cured composition can be disposed over, encapsulate, or otherwise cover at least a portion of an apparatus, device, or component thereof.

Illustrative, but non-limiting, examples of heat-generating members (for example, electrical/electronic apparatus and electrical/electronic devices include electric motors, electric generators, electric drives used for electromobility (e-mobility), or components thereof. E-mobility generally refers to the use of electric power train technologies used in applications such as electric cars, e-bikes, pedelecs, electric motorbikes, e-buses, e-trucks, among others, or components thereof. Other apparatus and devices include batteries, televisions, videos, computers, medical instruments, office machines, or communications devices, or devices/apparatus that give off heat, or components thereof.

Embodiments of the present disclosure also generally relate to articles that include a composition described herein. In some embodiments, an article includes a heat-generating member and a composition disposed over (or on) the heat-generating member. The composition disposed over (or on) the heat-generating member can be any suitable composition described herein. The composition can be a cured composition (or a cured product) that can contact, directly or indirectly, the heat-generating member.

The heat-generating member can be any suitable member that generates heat or thermal energy. Examples of heat-generating members can include an electronic device, an electrical device, an electronic apparatus, an electrical apparatus, a component thereof, or combinations thereof, such as those described herein. By, for example, contacting (either directly or indirectly) the heat-generating member with a thermally conductive composition described herein, the thermally conductive composition can transfer or pass thermal energy or heat from the heat-generating member to another element or itself. Accordingly, and in some embodiments, the composition can be used to keep temperature-sensitive elements in or around an electronic/electrical article within a prescribed operating temperature in order to avoid failure. In at least one embodiment, an article includes: a heat-generating member; and a composition described herein, the composition disposed on the heat-generating member.

In some embodiments, an article includes a heat-generating component and a heat-dissipating component disposed on (or over) a surface of the heat-generating component. The heat-generating component can be, or include, a heat-generating member. The heat-dissipating component can be, or include, a composition described herein. The composition can be a cured composition (or a cured product). The heat-dissipating component can contact, directly or indirectly, the heat-generating component. The heat-dissipating component can transfer or pass thermal energy (or heat) from the heat-generating member to another element or itself. The heat-dissipating component can be used to keep temperature-sensitive elements in or around an electronic/electrical article within a prescribed operating temperature in order to avoid failure.

In some embodiments, a heat generating component comprises a component of an electric motor, a component of an electric generator, a component of an electric drive, a component of a battery, a component of a television, a component of a computer, a component of a medical instrument, a component of an office machine, a component of a communications device, or combinations thereof, among others.

If desired, compositions described herein can be used for other applications such as for use in the coatings or adhesives industries. The compositions can be used generally for producing composites, adhesives, insulation materials, shaped products, binders, paints, sealants, laminates, among other articles and articles of manufacture.

In some embodiments, an article described herein can be made by suitable methods. In at least one embodiment, a method of forming an article comprises: positioning a curable composition in a mold, the curable composition comprising an aromatic epoxy resin, a latent catalytic curing agent, and a filler; heating the mold and the curable composition to form a cured composition; and positioning the cured composition on a heat-generating component to form the article. In some embodiments, heating the mold and the curable composition is performed at a temperature that is from about 100° C. to about 225° C., though other temperatures are contemplated.

The following examples are put forth so as to provide those of ordinary skill in the art with a complete disclosure and description of how to make and use embodiments of the present disclosure, and are not intended to limit the scope of embodiments of the present disclosure. Efforts have been made to ensure accuracy with respect to numbers used but some experimental errors and deviations should be accounted for.

### EXAMPLES

### Test Methods

Thermal conductivities of the compositions were determined according to ASTM E 1461.

### Example Compositions

Example compositions and comparative example compositions were prepared using the components shown in Table 1. The amounts shown in Table 1 are in units of weight percent unless indicated otherwise. The thermal conductivity of the compositions are also shown in Table 1. In Table 1, “C.Ex.” refers to a comparative example and “Ex.” refers to an example of the present disclosure. The example compositions are catalytic cured epoxies (using a latent catalytic curing agent). In contrast, the comparative example compositions utilize curatives as part of a two-component system (resin components and curative components) that require on-site mixing.

Epikote 828LVEL is a difunctional bisphenol-A-diglycidyl-ether epoxy resin; Epikote 162 is a bisphenol-F-diglycidyl-ether epoxy resin; Epikote 158 is a bisphenol-F-diglycidyl-ether epoxy resin; Epikote 496 is a tetra-glycidyl-methylene-dianiline epoxy resin; and Epikote 1031 is an epoxidized tetra-phenylethane epoxy resin, each of which is commercially available from Westlake Epoxy. Epikote 828LVEL, Epikote 162, Epikote 158, Epikote 496, and Epikote 1031 are used as epoxy resins.

Polypropylene glycol (400 g/mol), commercially available from Hexion Inc. under the trade name Heloxy, was used as a modifier. Boron trichloride dimethyloctylamine complex and 1-methylimidazole, both commercially available from Hexion Inc., were used as catalysts. Fillers included Millisil W12 EST commercially available from Quarzwerke Group, Tremin 283-100 EST commercially available from Quarzwerke Group, and SiC commercially available from ESD-SIC.

The comparative examples include curative components. Such curative components include: methyl nadic anhydride (also known as methyl-5-norbornene-2,3-dicarboxylic anhydride; CAS No. 25134-21-8) commercially available from Polynt; DBU is 1,8-diazabicyclo[5.4.0]undec-7-ene (CAS No. 6674-22-2) commercially available from BASF; the additives which are air release agents (polysiloxanes) and anti-settling agents (urea-modified, medium-polarity polyamide); Genioperl W35 (a modifier) is commercially available from Wacker Chemie.

The example compositions were made according to the following non-limiting procedure. Prior to blending the materials, the resin and the fillers were individually heated at a temperature of about 70° C. for about 2 hours. Following removal of the heat (so that the latent catalytic curing agent does not react), the resin, filler, and the latent catalytic curing agent were then charged into a vessel and mixed at about 500 revolutions per minute (rpm) to about 1,000 rpm and at a pressure of about 50 mbar (˜5,000 Pa). The compositions were delivered into individual molds, and the compositions were cured in the mold using a time and temperature profile which results in full cure or sufficient cure to release the cure composition from the mold after the cure cycle. In these examples, the following cure profile was used: hold at about 100° C. for about 2 hours, ramp to about 190° C. and cure at about 190° C. for about 3 hours. The cured compositions were allowed to cool to room temperature. The cured compositions were then removed from the molds.

TABLE 1

| | C. Ex. 1 | Ex. 1 | C. Ex. 2 | Ex. 2a | Ex. 2b | C. Ex. 3 | Ex. 3 | C. Ex. 4 | Ex. 4 |
|---|---|---|---|---|---|---|---|---|---|
| Resin components | | | | | | | | | |
| Epikote 828LVEL, | 13.0 | — | 9.4 | — | — | 10.4 | — | 19.0 | — |
| wt % | | | | | | | | | |
| Epikote 162, wt % | — | 9.4 | — | 7.0 | 6.9 | — | 6.1 | — | 13.6 |
| Epikote 158, wt % | — | 28.3 | — | 20.9 | 20.8 | — | 18.4 | — | 40.8 |
| Epikote 496, wt % | 4.4 | — | 3.2 | — | — | 3.6 | — | 6.5 | — |
| Epikote 1031, wt % | — | — | — | — | — | | 6.1 | — | — |
| Polypropylene glycol, | 0.2 | — | 0.2 | — | — | 0.2 | — | 0.3 | — |
| wt % | | | | | | | | | |
| Boron-trichloride- | — | — | — | — | 1.1 | — | 1.1 | — | — |
| octylamine complex, | | | | | | | | | |
| wt % | | | | | | | | | |
| 1-methylimidazole, | — | 0.8 | — | 0.6 | | — | — | — | 1.1 |
| wt % | | | | | | | | | |
| Millisil W12 EST, | 2.4 | — | 32.8 | 71.6 | 71.2 | 31.5 | 68.2 | — | — |
| wt % | | | | | | | | | |
| Tremin 283-100 EST, | 25.7 | 61.5 | — | — | — | — | — | — | — |
| wt % | | | | | | | | | |
| Silicon carbide, wt % | — | — | — | — | — | — | — | 21.1 | 44.5 |
| Total of resin | 45.8 | 100.0 | 45.6 | 100.0 | 100.0 | 45.6 | 100.0 | 46.9 | 100.0 |
| components, wt % | | | | | | | | | |
| Curative components | | | | | | | | | |
| Methyl nadic | 18.3 | — | 13.9 | — | — | 15.4 | — | 26.7 | — |
| anhydride, wt % | | | | | | | | | |
| 1-methylimidazole, | 0.1 | — | 0.1 | — | — | 0.1 | — | 0.1 | — |
| wt % | | | | | | | | | |
| DBU, wt % | 0.1 | — | 0.1 | — | — | 0.1 | — | 0.1 | — |
| Millisil W12 EST, | 2.5 | — | 39.2 | — | — | 37.5 | — | — | — |
| wt % | | | | | | | | | |
| Tremin 283-100 EST, | 31.7 | — | — | — | — | — | — | — | — |
| wt % | | | | | | | | | |
| Silicon carbide, wt % | — | — | — | — | — | — | — | 23.9 | — |
| Additives, wt % | 0.2 | — | 0.2 | — | — | 0.2 | — | 0.3 | — |
| Genioperl W35, wt % | 1.5 | — | 1.1 | — | — | 1.3 | — | 2.1 | — |
| Total of curative | 54.2 | — | 54.5 | — | — | 54.4 | — | 53.1 | — |
| components, wt % | | | | | | | | | |
| Total of resin and | 100.0 | 100.0 | 100.0 | 100.0 | 100.0 | 100.0 | 100.0 | 100.0 | 100.0 |
| curative components | | | | | | | | | |
| Thermal conductivity | 0.54 | 0.61 | 0.84 | 0.96 | 1.02 | 0.80 | 0.91 | 0.51 | 0.57 |
| (23° C.), W/mK | | | | | | | | | |

The thermal conductivity data in Table 1 indicates that the example compositions have enhanced thermal conductivity—about 10% to about 15%—over the comparative compositions. For example, Comparative Example 1—which includes EP828LVEL and wollastonite filler—has a thermal conductivity of about 0.54 W/mK, while Example 1—which includes about 25% EP162, 75% EP158, and the same quantity of wollastonite filler—has a higher thermal conductivity of about 0.61 W/mK. Although Example 2, Example 3, and Comparative Example 2 include the same Millisil filler (about 72%), the thermal conductivities of Example 2a (about 0.96 W/mK) and Example 2b (about 1.02 W/mK) are significantly improved over Comparative Example 2 (0.84 W/mK). Similarly, while Example 3 and Comparative Example 3 include the same Millisil filler (about 69%), the thermal conductivity of Example 3 (about 0.91 W/mK) is significantly improved over Comparative Example 3 (0.8 W/mK). Further, although Example 4 and Comparative Example 4 include the same silicon carbide filler, Example 4 (about 0.57 W/mK) has an enhanced thermal conductivity over Comparative Example 4 (0.51 W/mK). While not wishing to be bound by theory, it is believed that the higher aromatic content of the example compositions leads to the significant improvement in thermal conductivity. For example, while each of the comparative examples are diluted with curative components, the example compositions of the present disclosure are not diluted with the curative components. This lack of dilution leads to the relatively higher aromatic content of the example compositions as compared to the comparative examples. In addition, and unlike the comparative examples that include an anhydride curative (methyl nadic anhydride), the Examples of the present disclosure are free of anhydrides. Anhydrides can be a concern due to their respiratory-sensitizing effects.

The thermal conductivity data also illustrates that compositions of the present disclosure can be utilized for thermal management of heat-generating elements, for example, to transfer or pass thermal energy or heat from the heat-generating element to a different element or itself. For example, the compositions of the present disclosure can be utilized with a heat-generating device, a heat-generating apparatus, a component thereof, or combinations thereof. By contacting (either directly or indirectly) the composition described herein with the heat-generating device, a heat-generating apparatus, or a component thereof, the composition can be utilized to keep temperature-sensitive elements within a prescribed operating temperature in order to avoid failure.

The examples also demonstrate that compositions described herein can be single component systems (1K systems) as polymerization does not occur prior to application of a stimulus, for example, heat (for example, the cure profile). Compositions of the present disclosure can also be stored at ambient temperatures. In contrast, the comparative compositions for thermal management are 2K systems which require mixing on-site.

Unlike conventional compositions for thermal management which are typically 2K systems requiring mixing on-site, embodiments described herein can be single component systems as polymerization does not occur prior to application of a stimulus such as heat. For example, compositions of the present disclosure can include an epoxy resin, a catalytic curing agent, a filler, and an optional additive. Upon application of a stimulus, such as heat, the latent catalytic curing agent causes, for example, polyaddition reactions to occur and resulting in coupling, cross-linking, or both, of the epoxy resin among other materials. The compositions can be curable compositions that can be stored under ambient conditions. Conventional compositions for thermal management lack such abilities as they are not single component systems

Here, and relative to conventional technologies, use of the thermally conductive compositions described herein can significantly improve the efficiency of state-of-the-art electrical and electronic devices. This is because compositions of the present disclosure show improved thermal conductivity (that is, improved heat dissipation from heat-generating components) which, in turn, can better reduce the operating temperature of such electrical and electronic devices. As a consequence, the reduced operating temperature enabled by compositions of the present disclosure permit increased power output relative to conventional technologies for heat dissipation.

Overall, the thermal conductivity data of the example compositions indicates that, relative to conventional compositions, the compositions of the present disclosure can provide lower operations temperature when used with an electrical apparatus. This beneficial, lower operations temperature can lead to lower electric losses from electrical apparatus and reduced thermal aging of electrical apparatus. This can be especially true for electric drives used for electromobility (e-mobility), as electric drives used for e-mobility typically operate at the highest temperatures of e-mobility devices. As described above, e-mobility generally refers to the use of electric power train technologies used in applications such as electric cars, e-bikes, pedelecs, electric motorbikes, e-buses, e-trucks, among others. Moreover, the compositions described herein can be free of acid anhydrides as curatives. Acid anhydrides can be a concern due to their respiratory-sensitizing effects.

Embodiments of the present disclosure generally relate to epoxy resin compositions, methods of making epoxy resin compositions, and to uses of epoxy resin compositions. Embodiments described herein can be used to dissipate heat from a heat-generating device, a heat-generating apparatus, or a component thereof, such as electrical and electronic devices, electrical and electronic apparatus, or components thereof. The compositions can be curable compositions that can be stored under ambient conditions.

As used herein, reference to an R group, alkyl, substituted alkyl, hydrocarbyl, or substituted hydrocarbyl without specifying a particular isomer (such as butyl) expressly discloses all isomers (such as n-butyl, iso-butyl, sec-butyl, and tert-butyl). For example, reference to an R group having 4 carbon atoms expressly discloses all isomers thereof. When a compound is described herein such that a particular isomer, enantiomer or diastereomer of the compound is not specified, for example, in a formula or in a chemical name, that description is intended to include each isomer and enantiomer of the compound described individual or in any combination.

As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element, a group of elements, or a method is preceded with the transitional phrase “comprising,” it is understood that we also contemplate the same composition, method. or group of elements with transitional phrases “consisting essentially of,” “consisting of,” “selected from the group of consisting of,” or “Is” preceding the recitation of the composition, element, elements, or method, and vice versa, such as the terms “comprising,” “consisting essentially of,” “consisting of” also include the product of the combinations of elements listed after the term.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. For example, the recitation of the numerical range 1 to 5 includes the subranges 1 to 4, 1.5 to 4.5, 1 to 2, among other subranges. As another example, the recitation of the numerical ranges 1 to 5, such as 2 to 4, includes the subranges 1 to 4 and 2 to 5, among other subranges. Additionally, within a range includes every point or individual value between its end points even though not explicitly recited. For example, the recitation of the numerical range 1 to 5 includes the numbers 1, 1.5, 2, 2.75, 3, 3.80, 4, 5, among other numbers. Thus, every point or individual value may serve as its own lower or upper limit combined with any other point or individual value or any other lower or upper limit, to recite a range not explicitly recited.

As used herein, the indefinite article “a” or “an” shall mean “at least one” unless specified to the contrary or the context clearly indicates otherwise. For example, aspects comprising “a filler” includes aspects comprising one, two, or more fillers, unless specified to the contrary or the context clearly indicates only one filler is included.

While the foregoing is directed to aspects of the present disclosure, other and further aspects of the disclosure may be devised without departing from the basic scope thereof, and the scope thereof is determined by the claims that follow.

What is claimed is:

1. An article, comprising:
a heat-generating member; and
a composition disposed on the heat-generating member, the composition comprising:
an aromatic epoxy resin;
a latent catalytic curing agent, the latent catalytic curing agent being active at a temperature that is from about 30° C. to about 300° C.; and
a filler.

2. The article of claim 1, wherein the aromatic epoxy resin has an aromatic content of about 30 wt % to about 70 wt %, based on the total weight % of the aromatic epoxy resin.

3. The article of claim 1, wherein the aromatic epoxy resin is selected from the group consisting of a difunctional bisphenol-A-diglycidyl-ether, a bisphenol-F-diglycidyl-ether, a tetra-glycidyl-methylene-dianiline, an epoxidized tetra-phenylethane, a derivative thereof, and combinations thereof.

4. The article of claim 1, wherein the latent catalytic curing agent is selected from the group consisting of an imidazole, a substituted imidazole, an imidazole adduct, an imidazole complex, a tertiary amine, an oligomeric polyethylenepiperazine, a quaternary ammonium compound, a quaternary phosphonium compound, a urea derivative, a boron trifluoride complex, a boron trichloride complex, an epoxy addition reaction product, a tetraphenylene-boron complex, an amine borate, an amine titanate, a metal acetylacetonate, a naphthenic acid metal salt, an octanoic acid metal salt, other metal salts, metal chelates, and combinations thereof.

5. The article of claim 1, wherein the latent catalytic curing agent is selected from the group consisting of boron trichloride dimethyloctylamine, bis-(dimethylaminopropyl)-amino-2-propanol, N,N′-bis-(3-dimethylaminopropyl)urea, N-(2-hydroxypropyl)imidazole, dimethyl-2-(2-aminoethoxy)ethanol, bis(2-dimethylaminoethyl) ether, pentamethyldiethylenetriamine, dimorpholinodiethyl ether, 1,8-diazobicyclo[5.4.0]undec-7-ene, N-methylimidazole (also known as 1-methylimidazole), 1,2-dimethylimidazole, triethylenediamine, 1,1,3,3-tetra-methylguanidine, tin (IV) chloride, tin octoate, and combinations thereof.

6. The article of claim 1, wherein the latent catalytic curing agent is selected from the group consisting of a sulfonium salt of formula (I), a sulfonium salt of formula (II), a sulfonium salt of formula (III), a sulfonium salt of formula (IV), and combinations thereof: 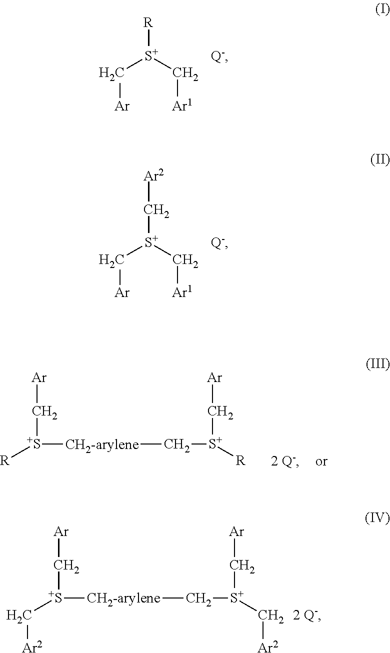
wherein, in formulas (I)-(IV):
each R group is, independently, C1-C12 alkyl, C3-C8 cycloalkyl, C4-C10 cycloalkylalkyl, or phenyl which is unsubstituted or monosubstituted or polysubstituted by C1-C8 alkyl, C1-C4 alkoxy, halogen, hydroxyl, nitro, phenyl, phenoxy, alkoxycarbonyl having 1-4 carbon atoms, or acyl having 1-12 carbon atoms;
each of Ar, Ar¹, or Ar² is, independently, phenyl, naphthyl, or fluorenyl, where the phenyl, naphthyl, or fluorenyl is unsubstituted or monosubstituted or polysubstituted by C1-C8 alkyl, C1-C4 alkoxy, halogen, hydroxyl, nitro, phenyl, phenoxy, alkoxycarbonyl having 1-4 carbon atoms, or acyl having 1-12 carbon atoms;
each arylene is, independently, phenylene, naphthylene, fluorenylene, where the phenylene, naphthylene, or fluorenylene is unsubstituted or monosubstituted or polysubstituted by C1-C8 alkyl, C1-C4 alkoxy, halogen, hydroxyl, nitro, phenyl, phenoxy, alkoxycarbonyl having 1-4 carbon atoms, or acyl having 1-12 carbon atoms; and
each Q⁻ is, independently, SbF₆⁻, AsF₆⁻, or SbF₅OH⁻.

7. The article of claim 1, wherein the filler is selected from the group consisting of silica, wollastonite, quartz, alumina, aluminum nitride, boron nitride, silicon nitride, silicon carbide, beryllium oxide, epoxy-silane pre-treated silica, epoxy-silane pre-treated wollastonite, and combinations thereof.

8. The article of claim 1, wherein the composition comprises:
about 20 wt % to about 70 wt % of the aromatic epoxy resin based on a total wt % of the composition;
about 30 wt % to about 80 wt % of the filler based on the total wt % of the composition; and
greater than 0 wt % and less than about 10 wt % of the latent catalytic curing agent, the total wt % of the composition not to exceed 100 wt %.

9. The article of claim 1, wherein the composition further comprises a polyhydric alcohol.

10. The article of claim 9, wherein the polyhydric alcohol is selected from the group consisting of ethylene glycol, propylene glycol, polyethylene glycol, polypropylene glycol, glycerols, a sugar compound, and combinations thereof.

11. The article of claim 1, wherein the latent catalytic curing agent is active at a temperature of about 50° C. to about 275° C.

12. An article, comprising:
a heat-generating component; and
a heat-dissipating component disposed over a surface of the heat-generating component, the heat-dissipating component comprising a cured composition comprising an epoxy polymerization product of a curable composition, the curable composition comprising:
about 20 wt % to about 70 wt % of an aromatic epoxy resin based on a total wt % of the curable composition;
about 30 wt % to about 80 wt % of a filler based on the total wt % of the curable composition; and
greater than 0 wt % and less than about 10 wt % of a latent catalytic curing agent, the total wt % of the curable composition not to exceed 100 wt %.

13. The article of claim 12, wherein the heat-generating component comprises a component of an electric motor, a component of an electric generator, a component of an electric drive, a component of a battery, a component of television, a component of a computer, a component of a medical instrument, a component of an office machine, or a component of a communications device.

14. The article of claim 12, wherein the cured composition has a thermal conductivity that is from about 0.5 W/mK to about 2.0 W/mK.

15. The article of claim 12, wherein the aromatic epoxy resin is derived from bisphenol A, bisphenol F, tetraglycidyl-methylenedianiline, a halogenated bisphenol, a novolac, an ortho-aminophenol, a para-aminophenol, a flourenone bisphenol, a dicyclopentadiene, or combinations thereof.

16. The article of claim 12, wherein the curable composition is a 1K system.

17. The article of claim 12, wherein:
the curable composition further comprises an additive, the additive selected from the group consisting of a modifier, a block copolymer comprising a functionalized silicone, a silicone-containing block copolymer, an anti-foam agent, an anti-settling agent, an air-release agent, a pigment, an ultraviolet stabilizer, and combinations thereof; and
an amount of the additive in the curable composition is greater than 0 wt % and less than about 10 wt % based on the total wt % of the curable composition.

18. The cured composition of claim 17, wherein, when the curable composition comprises a modifier, the modifier is a polyhydric alcohol.

19. A method of forming an article, the method comprising:
positioning a curable composition in a mold, the curable composition comprising an aromatic epoxy resin, a latent catalytic curing agent, and a filler;
heating the mold and the curable composition to form a cured composition; and
positioning the cured composition on a heat-generating component to form the article.

20. The method of claim 19, wherein heating the mold and the curable composition is performed at a temperature that is from about 100° C. to about 225° C.
